(19) United States
(12) Patent Application Publication
(10) Pub. No.: US 2010/0088161 A1
(43) Pub. Date: Apr. 8, 2010

(54) METHOD AND TOOL FOR CORPORATE KNOW-HOW AND INTELLECTUAL PROPERTY ASSETS REPRESENTATION AND MANAGEMENT

(75) Inventors: Riccardo PARENTI, PIEVE LIGURE (IT); Roberto GAROSI, GENOVA (IT); Gianni MOLINI, GENOVA (IT)

Correspondence Address: GREENBLUM & BERNSTEIN, P.L.C., 1950 ROLAND CLARKE PLACE, RESTON, VA, 20191, US

(73) Assignee: ANSALDO ENERGIA S.P.A, GENOVA (IT)

(21) Appl. No.: 12/244,287

(22) Filed: Oct. 2, 2008

(51) Int. Cl. G06Q 10/00; G06Q 50/00

(52) U.S. Cl. 705/11; 705/7

(57) ABSTRACT

A graphic tool and a method are provided, to represent corporate data in terms of know-how and intellectual property management risk and in terms of corporate functional breakdown by asset. The tool and method may be used to evaluate risk associated with events related to know-how and intellectual property management and capable of affecting or interrupt production. The tool and method also allow analysis of company production structure, for the purpose of functional or corporate reorganization.

The present invention relates to a graphic instrument representative of corporate data, to a corporate data management tool and to a method for managing know-how and intellectual property assets and method for managing know-how and intellectual property assets.

### BACKGROUND OF THE INVENTION

As it is well known, several instruments have been designed to support and optimizing strategic management of corporate assets. The aim of such tools is generally to provide a representation of corporate assets and outcome of activities in measurable terms. The current state and the expected dynamic evolution of corporate assets is described using proper sets of parameters and tracing modifications of parameters themselves in response to corporate actions and external events. In this manner, it is possible to plan actions, assess effects of actions carried out, observe trends of parameters relating to corporate assets and the like. Management tools often rely upon graphic representation of assets and actions. Examples of widely used tools of this kind are Gantt and PERT diagrams, that allow comprehensive representation of resources and time allocated to specific activities, progress of projects and interconnections between several activities; tools for graphic representation of cash flow; network charts to support logistics.

Corporate management is thus improved at any level by use of strategic management tools, in that results of decisions may be planned and verified and corrective actions may be taken, if required.

Intellectual property and know-how are widely recognized as strategic corporate assets. Therefore, efficient management of intellectual property and know-how is commonly felt as a primary need. Nevertheless, specific management tools are still inappropriate to support intellectual property and know-how strategic development.

Available tools are normally designed to provide assistance in processes that lead to filing of applications for intellectual property rights, once potentially inventive issues have been created, or in management of patent, design and trademark portfolios (maintenance policy, licensing, acquisition, disposal).

However, due to lack of specific tools, conventional policies for management of intellectual property and know-how aim at implementing scarcely focused actions and do not provide clear guidance in creating and enhancing intellectual property assets. Typical actions considered by intellectual property management policies relate to improving awareness, at corporate level, of intellectual property growth and techniques for know-how capitalization. As a result, know-how and innovations that deserve protection tend to increase without specific focus on corporate business objectives. In most cases, the creation of a specialized intellectual property portfolio requires selection of already existing intellectual property items to be prosecuted, maintained or abandoned.

### SUMMARY OF THE INVENTION

According to one embodiment of the invention, a graphic instrument representative of corporate data, comprises a first coordinate, for representing a first parameter indicative of a sensitive-knowledge protection degree associated with assets involved in at least one corporate process, and a second coordinate, for representing a second parameter indicative of a cost to be incurred due to said asset being unavailable because of adverse event relating to sensitive-knowledge, whereby an intellectual property risk associated with the process is synthetically represented.

According to another embodiment of the invention, a corporate data management tool comprises at least one input module, for collecting asset data from corporate units, and processing modules, configured to process collected asset data for determining synthetic representations of intellectual property risk associated with individual assets;

wherein synthetic representations include a graphic instrument representative of corporate data and comprising a first coordinate, for representing a first parameter indicative of a sensitive-knowledge protection degree associated with assets involved in at least a corporate process, and a second coordinate, for representing an intellectual property risk associated with the process.

According to another embodiment of the invention, a method for managing corporate data comprises:

collecting asset data from corporate units; and

determining synthetic representations of intellectual property risk associated with individual asset, based on collected asset data;

wherein synthetic representations include a graphic instrument representative of corporate data and comprising a first coordinate, for representing a first parameter indicative of a sensitive-knowledge protection degree associated with assets involved in at least a corporate process, and a second coordinate, for representing an intellectual property risk associated with the process.

According to another embodiment, the method comprises:

supplying the graphic instruments to management corporate units;

determining corrective actions and adjusted corporate target based on supplied graphic instruments, to minimize corporate risk and bring asset parameters into confidence regions; and

returning instructions for implementing corrective actions to operative corporate units.

According to another embodiment, the method comprises:

acquiring a corporate unit;

determining said graphic instruments for the acquired corporate unit;

using graphic instruments to perform asset based decomposition and asset productivity evaluation and asset risk analysis for the acquired corporate unit; and

reorganizing the acquired company unit, based on and outcome of the evaluation of the asset based decomposition, asset productivity evaluation and asset risk analysis.

### BRIEF DESCRIPTION OF THE DRAWINGS

For the understanding of the present invention, some embodiments thereof will be now described, purely as non-limitative examples, with reference to the enclosed drawings, wherein:

FIG. 1 is simplified block diagram showing a corporate infrastructure implementing data management tools;

FIG. 2 is a flowchart of a method for managing corporate data according to one embodiment of the present invention;

FIG. 3 is a diagram relating to a step of the method of FIG. 2;

FIG. 4 is a diagram relating to another step of the method of FIG. 2;

FIG. 5 is a diagram relating to another step of the method of FIG. 2;

FIG. 6 is a first graphic representation of quantities relating to the method of FIG. 2;

FIG. 7 is a second graphic representation of quantities relating to the method of FIG. 2;

FIG. 8 is a third graphic representation of quantities relating to the method of FIG. 2;

FIG. 9 is a fourth graphic representation of quantities relating to the method of FIG. 2; and

FIG. 10 is a flowchart of a method for managing corporate data according to another embodiment of the present invention.

### DETAILED DESCRIPTION OF THE INVENTION

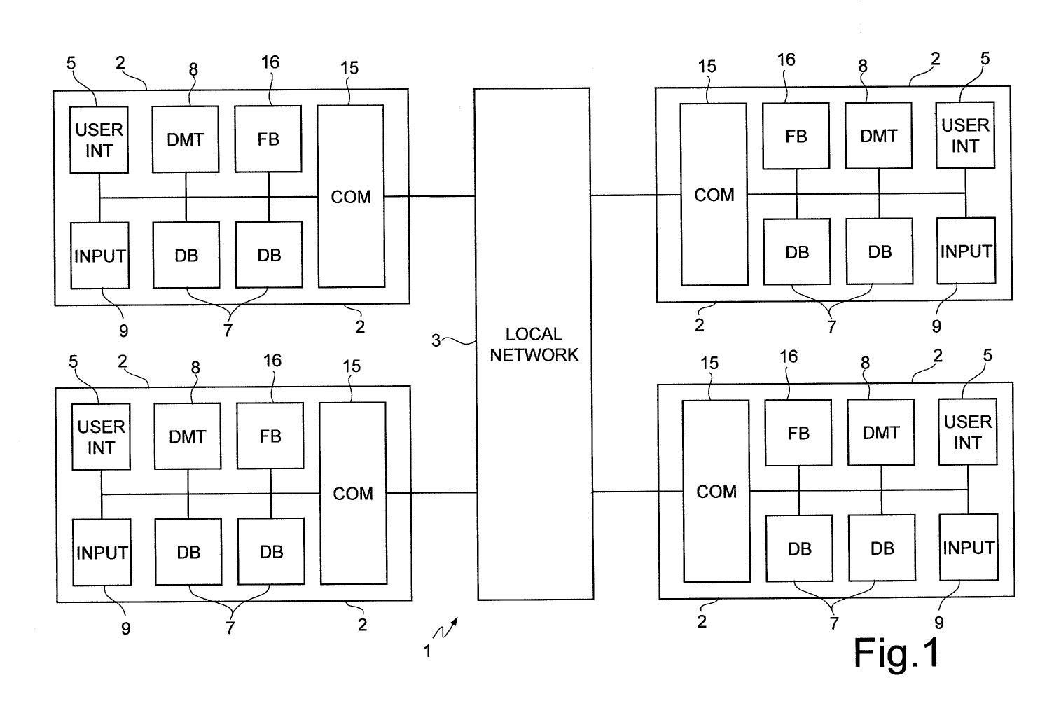

FIG. 1 schematically shows a distributed corporate data management system 1, that comprises a plurality of workstations 2, communicably coupled to one another via a local network 3. Workstations 2 are provided with user interfaces 5 and include a plurality of databases 7 and data management tools 8. Data management tools 8 may reside locally on each workstation 2 in one embodiment, or may reside in a centralized data process facility (here not shown), remotely accessible from workstations 2, in another embodiment.

Data management tools 8 are provided with input modules 9 to collect asset data AD from corporate units through user interfaces 5, and comprise processing modules 10, configured to process collected asset data AD for determining measures and synthetic representations of intellectual property risk associated with individual assets and for producing synthetic representation of asset status.

Here and in the following description, “intellectual property risk” will be used to mean any risks related to incomplete protection of assets, to incomplete formalization of corporate know-how and to actions of other owners of intellectual property rights. Accordingly, collected asset data AD include parameters representative of risk to have assets unavailable, e.g. because of conflicts with intellectual property rights of others; parameters representative of an extent of asset coverage by owned intellectual property rights; and parameters representative of an extent of formalization of corporate information and skills.

Moreover the definition “sensitive-knowledge” will be understood as including all technical and procedural information and skills involved in corporate business and are encompassed by usual meaning of intellectual property and know-how.

Data management tools 8 further comprise communication modules 15, configured to share processed data within management corporate units entrusted with the task of monitoring intellectual property and know-how development, so that strategic and operative decisions may be taken on the basis of synthetic representations of corporate intellectual property risk.

In one embodiment, data management tools 8 are further provided with feedback modules 16, configured to collect guidelines for implementing corrective actions from management corporate units and to provide end operators with guidelines, objective and corrective actions to be implemented.

The corporate data management system 1 may be used to manage corporate intellectual property risk as described hereinafter.

The term “company” will be used to designate either an individual company or a group of companies.

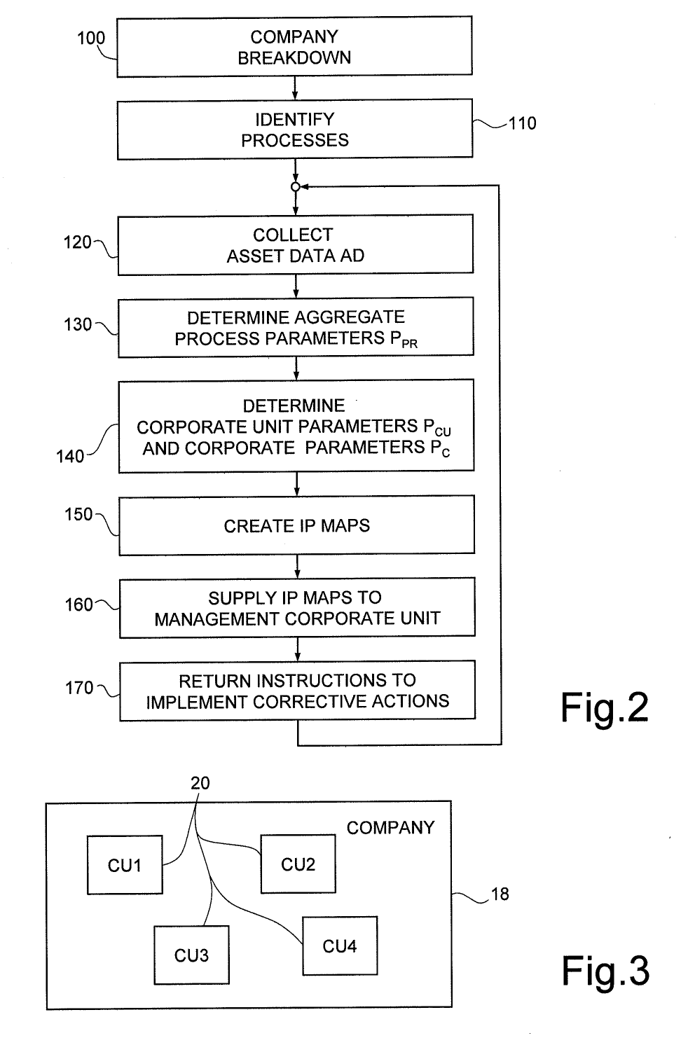

As illustrated in FIGS. 2 and 3, a company 18 is initially broken down (FIG. 2, block 100) into corporate units 20 (FIG. 3). Each corporate unit 20 may include for example a whole company (in case of company groups), a company branch, a division, a business unit, a plant or facility.

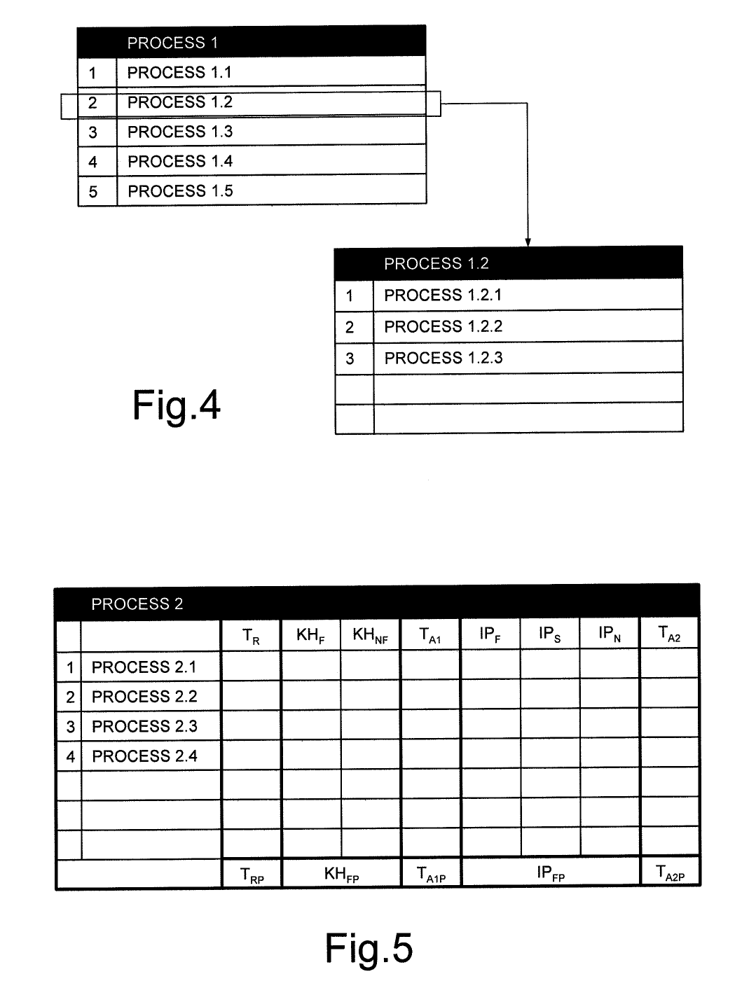

Then (FIG. 2, block 110), processes relevant to every single corporate unit 20 and adding to overall corporate value are identified and described in terms of input/transformation/output. Complex processes may be iteratively broken down into elementary processes, through as many steps as required. An example is shown in FIG. 4.

Once processes have been identified and described, asset data AD are collected through user interfaces 5 and input modules 9 and associated with relevant elementary processes (FIG. 1; FIG. 2, block 120; FIG. 5). According to one embodiment, asset data AD comprise, for each elementary process, a replacement time T_{R}, a formalized know-how parameter KH_{NF}, a non-formalized know-how parameter KH_{NF}, a first adverse event time T_{A1}, a formal IP (intellectual property) protection parameter IP_{F}, a secrecy IP protection parameter IPₛ, an IP protection lack parameter IP_{N} and a second adverse event time T_{A2}.

The replacement time T_{R} is a process criticality parameter and is indicative of cost to be incurred because of process stop in case an asset involved in said process is made unavailable, e.g. due to conflicts with intellectual property rights of others or turnover of human resources. The replacement time T_{R} indicates the time required to replace the unavailable asset with another equivalent asset, so that the previous operative capability is restored. “Operative capability” as herein understood encompasses at least production levels, that may have been hindered because of the loss of an operative asset; competitive advantages, that may have been reduced or eliminated because of poor intellectual property protection, loss of rights or the ability of competitors in designing around the scope of current intellectual property protection; and overall information and skill, that may be impaired due to turnover of managers or skilled workers.

In one embodiment, formalized know-how parameter KH_{F} and non-formalized know-how parameter KH_{NF} are complementary fractional or percentage values that provide an estimate of the extent to which a knowledge, information or skill has or, respectively, has not been formally expressed by corporate documents.

The first adverse event time T_{A1} is an estimate of a time interval within which no adverse events are expected, relative to know-how involved in a process. For example, skilled workers may be expected to stay with the company for certain time, because of improved treatment.

The formal IP protection parameter IP_{F} provides an estimate of the extent to which technical assets involved in a process are protected by utility or design patents or by trademarks or by measures intended to preserve secret information, in accordance with prescriptions of law (measures to prevent access of unauthorized persons to sensitive information, physical and logic restrictions, protected areas, labeling and advising, tracking of accesses to sensitive information and so on)

The secrecy IP protection parameter IP_{S} is indicative of an extent to which technical assets are protected by measures intended to keep confidentiality, including any information collected in corporate documents that are classified as not available to others, but that may not have sufficient requirements to reach protection by law. The IP protection lack parameter IP_{N} is indicative of an extent to which technical assets lack any intellectual property protection.

In one embodiment, the formal IP protection parameter IP_{F}, the secrecy IP protection parameter IP_{S} and the IP protection lack parameter IP_{N} are complementary fractional or percentage values.

The second adverse event time T_{A2} is an estimate of a time interval within which no adverse events, that are related to lack of adequate intellectual property protection and may have been avoided, at least in theory, by means of a more comprehensive intellectual property protection, are expected, relative to assets involved in a process. For example, a patented product or method may be expected to be available for a period, in that licenses have been obtained from the patent owner.

Collected asset data AD are then processed to determine aggregate process parameters P_{PR} (FIG. 2, block 130), that in one embodiment include an aggregate process replacement time T_{RP}, an aggregate process know-how formalization parameter KH_{FP}, an aggregate process first adverse event time T_{A1P}, an aggregate process IP protection parameter IP_{FP} and an aggregate process second adverse event time T_{A2P}.

Processing method may be carried out on a conservative basis. In one embodiment, aggregated process parameters are calculated as follows.

The aggregate process replacement time T_{RP} is the maximum of process replacement times T_{R} of corresponding elementary processes.

The aggregate process know-how formalization parameter KH_{FP} is the ratio of the sum of formalized know-how parameter KH_{F} of elementary processes to the total of formalized know-how parameter KH_{F} and non-formalized know-how parameter KH_{FN}.

The aggregate process first adverse event time T_{A1P} is the minimum of first adverse event times T_{A1} Of elementary processes.

The aggregate process IP protection parameter IP_{FP} is the ratio of the sum of the formal IP protection parameters IP_{F} of the elementary processes to the total of formal IP protection parameters IP_{F}, of secrecy IP protection parameters IP_{S} and of IP protection lack parameters IP_{N}.

The aggregate process second adverse event time T_{A2P} is the minimum of second adverse event times T_{A2} of elementary processes.

Aggregate process parameter P_{PR} may be further processed to determine corporate unit parameters P_{CU} and corporate parameters P_{C} (FIG. 2, block 140). As already mentioned, a corporate unit as herein understood may include, for example, a company, a company branch, a division, a business unit, a plant or facility. In one embodiment, in particular, corporate unit parameters P_{CU} are weighed according to economic and strategic importance of individual corporate units, in order to determine corporate parameters P_{C}.

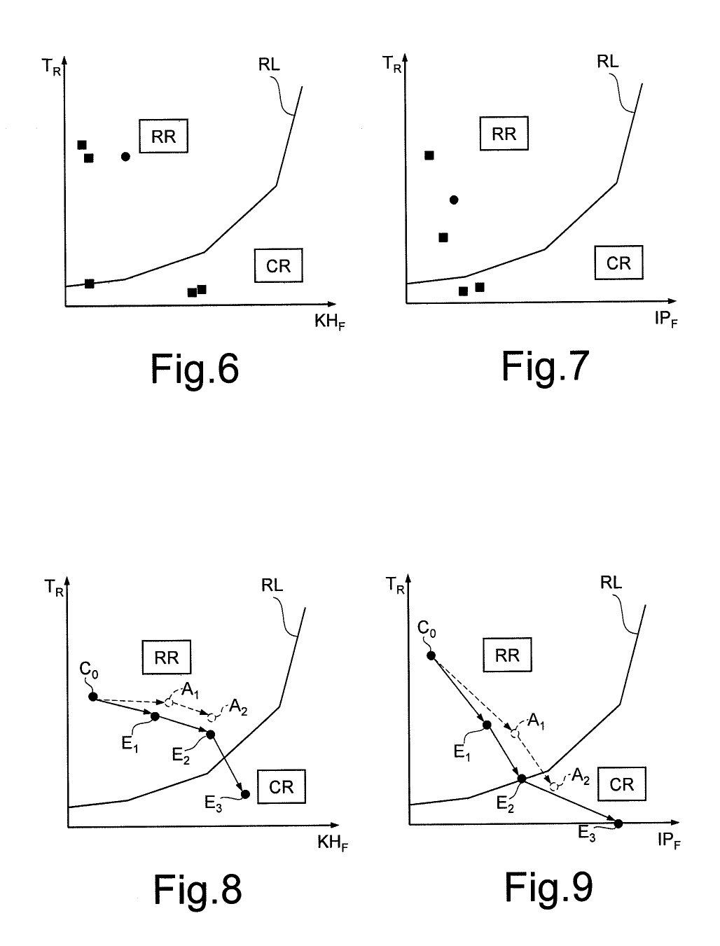

Collected asset data AD, aggregate process parameters P_{PR}, and corporate parameters P_{C} are then combined to create IP maps (FIG. 2, block 150). FIGS. 6 and 7 show two exemplary IP maps 25 relating to collected asset data AD and aggregate process parameters P_{PR} for a process (round signs) that involves five elementary processes (square signs). More precisely, IP map 25 illustrated in FIG. 6 represents know-how formalization vs. replacement time on a coordinate plane. Know-how formalization is defined by the formalized know-how parameter KH_{F} for elementary process and by the aggregate process know-how formalization parameter KH_{FP} for the aggregate process. Likewise, replacement time is defined by individual replacement times T_{R} for elementary processes and by the aggregate process replacement time T_{RP} for the aggregate process. A risk line RL that divides the coordinate plane in two complementary regions may be determined as a function also of the adverse event expected time. A first area below the risk line defines a confidence region CR, in which risk associated with know-how and intellectual property is considered under control, because know-how formalization is sufficiently high and the time expected to be safe from adverse events is sufficiently long compared to time required to implement measures for restoring loss or reduction of operative levels. A second area above the risk line defines a risk region RR, in which risk associated with know-how and intellectual property is not considered under control.

IP map 25′ illustrated in FIG. 6 intellectual property protection vs. replacement time on another coordinate plane.

Intellectual property protection in one embodiment may be defined by the formal IP protection parameter IP_{F} for the elementary processes and by the aggregate process IP protection parameter IP_{FP}, while replacement time is still defined by individual replacement times T_{R} for elementary processes and by the aggregate process replacement time T_{RP} for the aggregate process.

Also in this case a risk line, a confidence region CR and a risk region RR may be defined as explained above.

IP maps 25, 25′ are supplied to management corporate units 20 (FIG. 2, block 160), that may plan corrective actions, adjust corporate target to minimize corporate risk and possibly bring asset parameters into confidence regions.

Guidelines and instructions for implementing corrective actions and plans are returned to operative corporate units 20 through the local network 3 (FIG. 2, block 170).

Collection of asset data AD, calculation of aggregate process parameters P_{PR} and corporate parameters P_{C} and generation of IP maps 25 may be iteratively repeated, to trace changes of corporate protection and evaluate compliance to strategic targets and plans. In exemplary IP maps 25, 25′ illustrated in FIGS. 8 and 9, planned evolution (E₁, E₂, E₃) from an initial condition (C₀) of aggregated process data is indicated by solid line dots and arrows. Actual evolution (A₁, A₂), as assessed through newly collected asset data AD, is instead represented by dashed dots and lines.

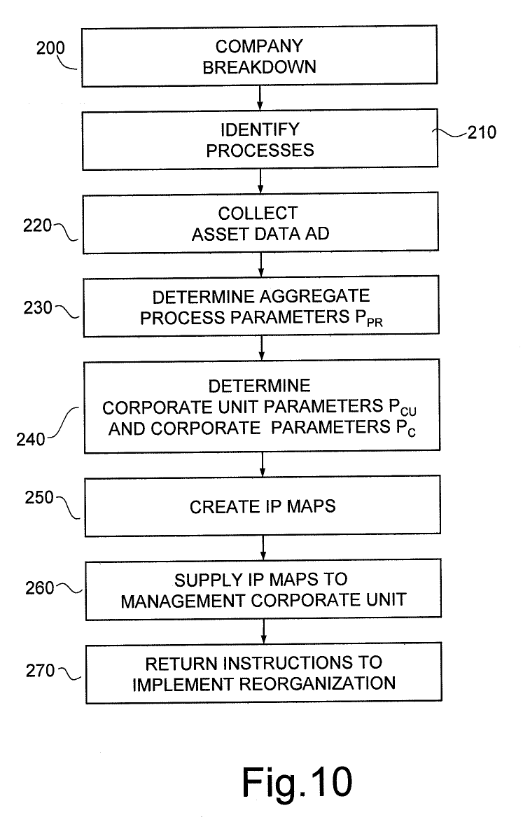

In another embodiment, illustrated in FIG. 10, the corporate data management system 1 is used to assess the state of know-how and intellectual property in case of planned acquisition of an additional company or corporate unit. After breakdown of the additional company, (block 200, asset based decomposition), process identification (block 210), collection of asset data AD (block 220), processing of collected asset data AD to determine aggregated process parameters P_{PR} (block 230), corporate unit parameters P_{CU} and corporate parameters P_{C} (block 240) and creation of IP maps (block 250), substantially as already described, all collected and processed data are supplied to a management corporate unit for productivity evaluation and risk analysis (block 260). Then, reorganization of the additional company is planned, based on outcome of productivity evaluation and risk analysis (block 270), and started upon acquisition. However, asset based decomposition, asset productivity analysis and asset risk analysis may be carried out in advance of acquisition, if data are available.

The system and method described above provide effective and flexible tools for corporate know-how and intellectual property management, in a production-oriented perspective. In particular, data management tools may be used to drive know-how and intellectual property development, through implementation of feedback actions, rather than simply relying on supported awareness and portfolio management. Thus, corporate resource may be optimized and focused on protection of strategic business.

Finally, it is clear that numerous modifications and variations may be made to the method described and illustrated herein, all falling within the scope of the invention, as defined in the attached claims.

1. A graphic instrument representative of corporate data, comprising a first coordinate, for representing a first parameter indicative of a sensitive-knowledge protection degree associated with assets involved in at least one corporate process, and a second coordinate, for representing a second parameter indicative of a cost to be incurred due to said asset being unavailable because of adverse event relating to sensitive-knowledge, whereby an intellectual property risk associated with the process is synthetically represented.

2. A graphic instrument according to claim 1, wherein the first parameter is indicative of an extent of formalization of know-how associated with the process.

3. A graphic instrument according to claim 1, wherein the first parameter is indicative of an extent of protection of intellectual property associated with the process.

4. A graphic instrument according to claim 1, wherein the second parameter is indicative of a time required to replace an asset become unavailable because of intellectual property rights of others, to restore corporate operative capability.

5. A graphic instrument according to claim 1, comprising a risk line, defining a confidence region, in which risk associated with know-how and intellectual property is considered under control, and a risk region, in which risk associated with know-how and intellectual property is not considered under control.

6. A corporate data management tool comprising at least one input module, for collecting asset data from corporate units, and processing modules, configured to process collected asset data for determining synthetic representations of intellectual property risk associated with individual assets;
wherein synthetic representations include a graphic instrument representative of corporate data and comprising a first coordinate, for representing a first parameter indicative of a sensitive-knowledge protection degree associated with assets involved in at least a corporate process, and a second coordinate, for representing an intellectual property risk associated with the process.

7. A corporate data management tool according to claim 6, wherein the first parameter is indicative of an extent of formalization of know-how associated with the process.

8. A corporate data management tool according to claim 6, wherein the first parameter is indicative of an extent of protection of intellectual property associated with the process.

9. A corporate data management tool according to claim 6, wherein the graphic instrument comprises a risk line, defining a confidence region, in which risk associated with know-how and intellectual property is considered under control, and a risk region, in which risk associated with know-how and intellectual property is not considered under control.

10. A corporate data management tool according to claim 6, wherein the second parameter is indicative of a time required to replace an asset become unavailable because of intellectual property rights of others, to restore corporate operative capability.

11. A corporate data management tool according to claim 6, comprising at least one communication module, configured to share processed data within management corporate units entrusted with the task of monitoring intellectual property and know-how development.

12. A corporate data management tool according to claim 11, comprising at least one feedback module, configured to collect guidelines for implementing corrective actions from management corporate units and to provide end operators with guidelines, objective and corrective actions to be implemented.

13. A method for managing corporate data comprising:
collecting asset data from at least one corporate unit; and
determining synthetic representations of intellectual property risk associated with individual asset, based on collected asset data;
wherein synthetic representations include a graphic instrument representative of corporate data and comprising a first coordinate, for representing a first parameter indicative of a sensitive-knowledge protection degree associated with assets involved in at least a corporate process, and a second coordinate, for representing an intellectual property risk associated with the process.

14. A method according to claim 13, comprising:
breaking down a company into corporate units;
identifying processes relevant to each corporate unit; and
breaking down each process into elementary process.

15. A method according to claim 13, wherein asset data comprise, for each elementary process, a first replacement time, indicative of a cost to be incurred due to asset involved in said elementary process being unavailable because of intellectual property rights of others.

16. A method according to claim 15, wherein asset data comprise, for each elementary process, a formalized know-how parameter that provide an estimate of the extent to which know-how relating to said elementary process has been formally expressed by corporate documents.

17. A method according to claim 16, wherein asset data comprise, for each elementary process, a first adverse event time, that provides an estimate of a time interval within which no adverse events are expected, relative to know-how involved in said elementary process

18. A method according to claim 17, wherein asset data comprise, for each elementary process, a formal IP protection parameter, that provides an estimate of the extent to which technical assets involved in one elementary process are protected by proprietary intellectual property rights.

19. A method according to claim 18, wherein asset data comprise, for each elementary process, a secrecy IP protection parameter, indicative of an extent to which assets involved in said elementary process are protected by measures intended to keep corporate secrecy.

20. A method according to claim 19, wherein asset data comprise, for each elementary process, a second adverse event time, that provides an estimate of a time interval within which no adverse events related to lack of intellectual property protection are expected, relative to assets involved in said elementary process.

21. A method according to claim 20, comprising determining aggregate process parameters.

22. A method according to claim 21, wherein aggregate process parameters include:
an aggregate process replacement time, determined based on process replacement times of corresponding elementary processes;
an aggregate process know-how formalization parameter, determined based on formalized know-how parameter of elementary processes;
an aggregate process first adverse event time, determined based on first adverse event times of elementary processes;
an aggregate process IP protection parameter, determined based on formal IP protection parameters of the elementary processes; and
an aggregate process second adverse event time, based on second adverse event times of the elementary processes.

23. A method according to claim 13, comprising iteratively producing the graphic instruments.

24. A method according to claim 13, comprising:
supplying the graphic instruments to management corporate units;
determining corrective actions and adjusted corporate target based on supplied graphic instruments, to minimize corporate risk and bring asset parameters into confidence regions; and
returning instructions for implementing corrective actions to operative corporate units.

25. A method according to claim 13, comprising:
planning acquisition of an corporate unit;
determining said graphic instruments for the additional corporate unit;
using graphic instruments to perform asset based decomposition, asset productivity evaluation and asset risk analysis for the additional corporate unit; and
planning reorganization of the additional corporate unit, based on an outcome of the evaluation of the asset based decomposition, asset productivity evaluation and asset risk analysis.
